(19) United States
(12) Patent Application Publication
(10) Pub. No.: US 2014/0203759 A1
(43) Pub. Date: Jul. 24, 2014

(54) POWER SUPPLY SYSTEM OF VEHICLE AND VEHICLE INCLUDING SAME

(71) Applicant: Yoshinobu SUGIYAMA, Toyota-shi (JP)

(72) Inventor: Yoshinobu SUGIYAMA, Toyota-shi (JP)

(73) Assignee: TOYOTA JIDOSHA KABUSHIKI KAISHA, Toyota-shi (JP)

(21) Appl. No.: 14/152,186

(22) Filed: Jan. 10, 2014

(30) Foreign Application Priority Data
Jan. 21, 2013 (JP) 2013-008152

(51) Int. Cl. B60L 11/18

(52) U.S. Cl. CPC B60L 11/1809
USPC 320/104

(57) ABSTRACT

A power supply system of a vehicle includes: a first power storage device that stores power for travel; a second power storage device that stores power for auxiliary equipment; a voltage conversion device that is provided between the first power storage device and the second power storage device, and that charges the second power storage device through voltage conversion of power that is outputted by the first power storage device; and a control device that executes charging control of charging the second power storage device by way of the voltage conversion device, while the vehicle is parked. The control device determines an abnormality in the second power storage device on the basis of information relating to dark current in the second power storage device during parking, and, upon determination of abnormality in the second power storage device, sets the charging control to non-execution.

### INCORPORATION BY REFERENCE

The disclosure of Japanese Patent Application No. 2013-008152 filed on Jan. 21, 2013 including the specification, drawings and abstract is incorporated herein by reference in its entirety.

### BACKGROUND OF THE INVENTION

1. Field of the Invention

The invention relates to a power supply system of a vehicle and to a vehicle including the power supply system of a vehicle; more particularly, the invention relates to a power supply system of a vehicle, having a first power storage device that stores power for travel, and a second power storage device that stores power for auxiliary equipment, and relates to a vehicle including the power supply system of a vehicle.

2. Description of Related Art

Japanese Patent Application Publication No. 2006-174619 (JP 2006-174619 A) discloses a charge controller of a hybrid vehicle that is provided with a high-voltage main battery and a low-voltage auxiliary equipment battery. The charge controller is provided with a DC/DC converter for stepping down the voltage of the main battery and supplying the stepped-down voltage to the auxiliary equipment battery. In order to prevent the auxiliary equipment battery from being drained during parking, the auxiliary equipment battery is charged through driving of the DC/DC converter after a given time has elapsed since parking (JP 2006-174619 A).

When the auxiliary equipment battery is charged through driving of the DC/DC converter, the auxiliary equipment battery may exhibit abnormal heat generation despite having been determined to be in an abnormal condition by virtue of the fact that dark current in the auxiliary equipment battery during parking is larger than necessary.

### SUMMARY OF THE INVENTION

The invention provides a power supply system of a vehicle, having a first power storage device that stores power for travel, and a second power storage device that stores power for auxiliary equipment, wherein abnormal heat generation in the second power storage device is suppressed, and provides a vehicle that has the power supply system of a vehicle.

A first aspect of the invention relates to a power supply system of a vehicle. The power supply system of a vehicle has a first power storage device, a second power storage device, a voltage conversion device, and a control device. The first power storage device stores power for travel. The second power storage device stores power for auxiliary equipment. The voltage conversion device is provided between the first power storage device and the second power storage device, and charges the second power storage device through voltage conversion of power that is outputted by the first power storage device. The control device executes charging control of charging the second power storage device by way of the voltage conversion device, while the vehicle is parked. The control device determines an abnormality in the second power storage device on the basis of information relating to dark current in the second power storage device during parking, and, upon determination of abnormality in the second power storage device, sets the charging control to non-execution.

A second aspect of the invention relates to a power supply system of a vehicle. The power supply system of a vehicle has a first power storage device, a second power storage device, a voltage conversion device, and a control device. The first power storage device stores power for travel. The second power storage device stores power for auxiliary equipment. The voltage conversion device is provided between the first power storage device and the second power storage device, and charges the second power storage device through voltage conversion of power that is outputted by the first power storage device. The control device executes charging control of charging the second power storage device by way of the voltage conversion device, while the vehicle is parked. The control device sets the charging control to non-execution when it is determined that dark current in the second power storage device during parking is larger than a predefined value.

A third aspect of the invention relates to a vehicle. The vehicle has any one of the above-described power supply systems, and a driving device that generates a driving force by receiving power from the power supply system.

In the first through third aspects of the invention, charging control of charging the second power storage device by way of the voltage conversion device, is set to non-execution upon determination of abnormality in the second power storage device on the basis of the information relating to dark current in the second power storage device during parking. As a result, no power is fed from the first power storage device to the second power storage device during an abnormality in the second power storage device. The first through third aspects of the invention allow therefore suppressing abnormal heat generation in the second power storage device.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall configuration diagram of a vehicle having installed therein a power supply system according to an embodiment of the invention;

FIG. 2 is a diagram illustrating in detail the configuration of a control device illustrated in FIG. I;

FIG. 3 is a flowchart for explaining the process steps in pumping charging control that is executed by a control device according to an embodiment of the invention;

FIG. 4 is a flowchart for explaining the steps of a startup process of pumping charging, as executed in step S10 illustrated in FIG. 3; and

FIG. 5 is a diagram for explaining a method for determining abnormality in an auxiliary equipment battery according to an embodiment of the invention.

### DETAILED DESCRIPTION OF EMBODIMENTS

Embodiments of the invention will be explained next in detail with reference to accompanying drawings. Identical and equivalent portions in the figures are denoted by identical reference numerals, and a recurrent explanation thereof will be omitted.

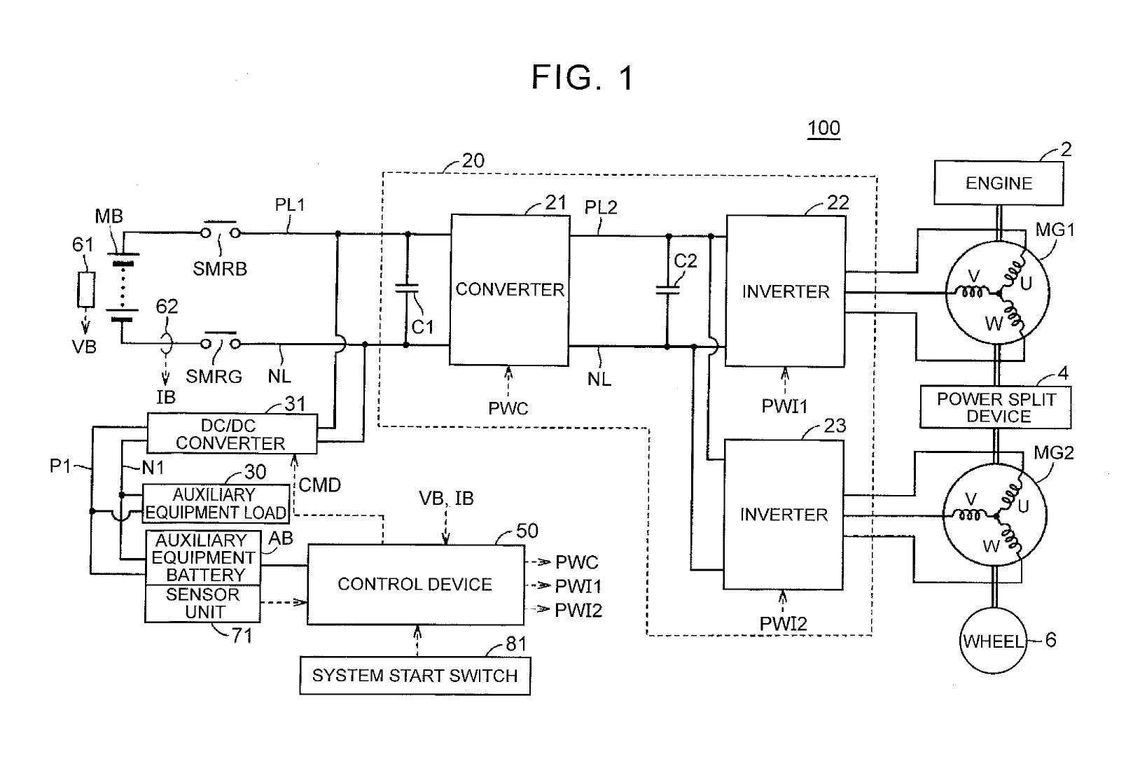

FIG. 1 is an overall configuration diagram of a vehicle having installed therein a power supply system according to an embodiment of the invention. With reference to FIG. 1, a vehicle 100 is provided with an engine 2, motor generators MG1, MG2, a power split device 4, a wheel 6, a power control unit (hereafter “PCU”) 20, a main power storage device MB, system main relays SMRB, SMRG, a voltage sensor 61 and a current sensor 62. The vehicle 100 is further provided with an auxiliary equipment battery AB, an auxiliary equipment load 30, a DC/DC converter 31, a sensor unit 71, a control device 50 and a system start switch 81.

The vehicle 100 is equipped with the motor generators MG1, MG2 and the engine 2 as drive sources. The engine 2, the motor generator MG1 and a drive shaft of the wheel 6 are connected to the power split device 4. The motive power generated by the engine 2 is split into two pathways by the power split device 4. In one pathway, power is transmitted to the drive shaft of the wheel 6, and in the other pathway, power is transmitted to the motor generator MG1.

The motor generator MG1 operates mainly as a power generator that is driven by the engine 2, and is built, into the vehicle 100, as a motor generator that operates as a motor for starting the engine 2. The motor generator MG2 is connected to the drive shaft of the wheel 6 and is built into the vehicle 100 as a motor that drives the wheel 6. A speed reducer may be incorporated between the motor generator MG2 and the drive shaft of the wheel 6.

The power split device 4 is made up of a planetary gear that has a sun gear, pinion gears, a carrier, and a ring gear. The pinion gears engage with the sun gear and the ring gear. The carrier rotatably supports the pinion gears and is connected to the crankshaft of the engine 2. The sun gear is connected to a rotating shaft of the motor generator MG1. The ring gear is connected to a drive shaft of the wheel 6 (rotating shaft of the motor generator MG2).

The main power storage device MB is a rechargeable DC power source, and may be made up of, for instance, a secondary battery such as a nickel hydride battery or a lithium ion battery, or of an electric double layer capacitor. The main power storage device MB stores power for travel that is supplied to the motor generators MG1, MG2. Also, the main power storage device MB is charged by receiving, through the PCU 20, power that is generated by the motor generators MG1, MG2.

An auxiliary equipment battery AB is charged by being supplied with power that is stored in the main power storage device MB when a state where the vehicle 100 is parked continues for a predefined period (for instance, 12 days) (such charging of the auxiliary equipment battery AB that is executed while the vehicle is parked will be referred to hereafter as “pumping charging”). Herein “parking” denotes a state in which the vehicle system is shut down as a result of a switch-off operation of the system start switch 81.

The voltage sensor 61 detects a voltage VB of the main power storage device MB, and outputs the detection value to the control device 50. The current sensor 62 detects a current IB that is inputted and outputted to/from the main power storage device MB, and outputs the detection value to the control device 50.

The system main relay SMRB is connected between the positive electrode of the main power storage device MB and a positive electrode line PL1. The system main relay SMRG is connected between the negative electrode of the main power storage device MB and a negative electrode line NL. The system main relays SMRB, SMRG are switched on/off in response to a signal from the control device 50. Although not particularly depicted in the figures, a pre-charge circuit for preventing flow of inrush current from the main power storage device MB to the PCU 20 is provided in parallel with either of the system main relays SMRB, SMRG.

The PCU 20 has a converter 21, inverters 22, 23, and smoothing capacitors C1, C2. The converter 21 is provided between the positive electrode line PL1 and a positive electrode line PL2. On the basis of a signal PWC from the control device 50, the converter 21 boosts the voltage between the positive electrode line PL2 and the negative electrode line NL to be equal to or higher than the voltage between the positive electrode line PL1 and the negative electrode line NL (i.e. the output voltage of the main power storage device MB). For instance, the converter 21 is made up of a current-reversible boosting chopper circuit.

The inverters 22, 23 are connected to the positive electrode line PL2 and the negative electrode line NL. On the basis of a signal PWI1 from the control device 50, the inverter 22 converts alternating current (AC) power that is generated by the motor generator MG1 using the output of the engine 2 to DC power, and outputs the converted DC power to the positive electrode line PL2. On the basis of a signal PWI2 from the control device 50, the inverter 23 converts the DC power that is received from the positive electrode line PL2 to AC power, and outputs the converted AC power to the motor generator MG2. The inverters 22, 23 are each made up of, for instance, a bridge circuit that includes power semiconductor switching elements for three phases.

The motor generators MG1, MG2 are AC electric motors, and are made up of, for instance, a permanent magnet-type synchronous motor in which permanent magnets are embedded in a rotor. The motor generator MG1 generates AC power using the motive power of the engine 2 that is received via the power split device 4, and outputs the generated AC power to the inverter 22. By virtue of the AC power received from the inverter 23, the motor generator MG2 generates torque for driving the wheel 6.

The smoothing capacitor C1, which is electrically connected between the positive electrode line PL1 and the negative electrode line NL, smoothens the AC component of voltage fluctuation between the positive electrode line PL1 and the negative electrode line NL. The smoothing capacitor C2, which is electrically connected between the positive electrode line PL2 and the negative electrode line NL, smoothens the AC component of voltage fluctuation between the positive electrode line PL2 and the negative electrode line NL.

The DC/DC converter 31 is connected between the positive electrode line PL1 and the negative electrode line NL, and between a positive electrode line P1 and a negative electrode line N1 The auxiliary equipment battery AB and the auxiliary equipment load 30 are connected to the positive electrode line P1 and the negative electrode line N1. That is, the DC/DC converter 31 is provided between the main power storage device MB and the auxiliary equipment battery AB. On the basis of a signal CMD from the control device 50, the DC/DC converter 31 converts the voltage (step-down) of the power that is outputted by the main power storage device MB, and charges thereby the auxiliary equipment battery AB.

The auxiliary equipment load 30 denotes collectively the various items of auxiliary equipment that are installed in the vehicle 100. The auxiliary equipment battery AB is made up of a rechargeable DC power source, for instance a secondary battery such as a lead-acid battery, a nickel hydride battery, or a lithium ion battery. A capacitor may also be used instead of the auxiliary equipment battery AB. The auxiliary equipment battery AB stores power that is supplied through the DC/DC converter 31, and supplies the stored power to the auxiliary equipment load 30 and the control device 50. The auxiliary equipment battery AB supplies operating power to the control device 50, and hence the control device 50 becomes operationally disabled, and the vehicle 100 becomes accordingly operationally disabled as well, when the power storage amount in the auxiliary equipment battery AB decreases.

The sensor unit 71 detects the state of the auxiliary equipment battery AB. For instance, the sensor unit 71 detects the voltage of the auxiliary equipment battery AB, and the current that is inputted and outputted to/from the auxiliary equipment battery AB, and outputs the detection values to the control device 50. On the basis of the detected voltage and current, the sensor unit 71 may calculate the state of charge (referred to as “SOC”, and expressed followed by as 0 to 100%, where 100% denotes full charge) of the auxiliary equipment battery AB, and output the calculation result to the control device 50. An available method can be resorted to as the method for calculating the SOC.

The control device 50 controls the system main relays SMRB, SMRG, the PCU 20, the engine 2 and the DC/DC converter 31 by way of software processing in which a program stored beforehand is executed in a central processing unit (CPU), and/or by way of hardware processing relying on electronic circuitry.

As one of the main items of control executed by the control device 50, the control device 50 executes control (pumping charging control) for performing the above-described pumping charging, in order to inhibit the auxiliary equipment battery AB from being drained while the vehicle 100 is parked. Schematically, the control device 50 measures the parking time of the vehicle 100, such that when the parking time lasts for a predefined period (for instance, 12 days), the control device 50 generates the signal CMD for driving the DC/DC converter 31, and outputs the generated signal CMD to the DC/DC converter 31.

The control device 50 determines an abnormality in the auxiliary equipment battery AB on the basis of information relating to dark current in the auxiliary equipment battery AB during parking. Herein, dark current in the auxiliary equipment battery AB is current that is outputted by the auxiliary equipment battery AB also during parking where the vehicle system is in an off state. This dark current can be predicted based on the state of the auxiliary equipment load 30 during parking. The control device 50 determines thus that the auxiliary equipment battery AB is in an abnormal condition if the dark current is determined to be larger than predicted.

As an example, the auxiliary equipment battery AB is determined to be in an abnormal condition, in that dark current is larger than predicted, if the user connects an electrical load to the auxiliary equipment battery AB during parking. When pumping charging is executed under such circumstances, abnormal heat generation may occur on account of, for instance, loosening of the terminals that connect the electrical load to the auxiliary equipment battery AB. Therefore, the control device 50 sets pumping charging control to non-execution when it is determined that the auxiliary equipment battery AB is in an abnormal condition. Specifically, execution of pumping charging is prohibited, and pumping charging is shut down if it was in progress.

Herein, the information relating to dark current in the auxiliary equipment battery AB encompasses, besides the dark current itself, also physical quantities that vary with the magnitude of the dark current. For instance, a SOC decrease amount and a voltage decrease amount in the auxiliary equipment battery AB are larger when dark current is large. Accordingly, the control device 50 may determine the auxiliary equipment battery AB to be in an abnormal condition if the SOC decrease amount or the voltage decrease amount of the auxiliary equipment battery AB during parking is larger than a predefined reference value. Power consumption in the auxiliary equipment load 30 during parking can be estimated beforehand, and hence the above reference value can be established on the basis of power consumption in the auxiliary equipment load 30 during parking.

The system start switch 81 is a switch for enabling the user to start and shut down of the vehicle system, and corresponds to an ignition key (the ignition key may be used instead of the system start switch 81). When the user turns on the system start switch 81, the system start switch 81 outputs, to the control device 50, a start-up command that instructs system start in the vehicle 100. When the user turns off the system start switch 81, the system start switch 81 outputs, to the control device 50, a shutdown command that instructs system shutdown in the vehicle 100.

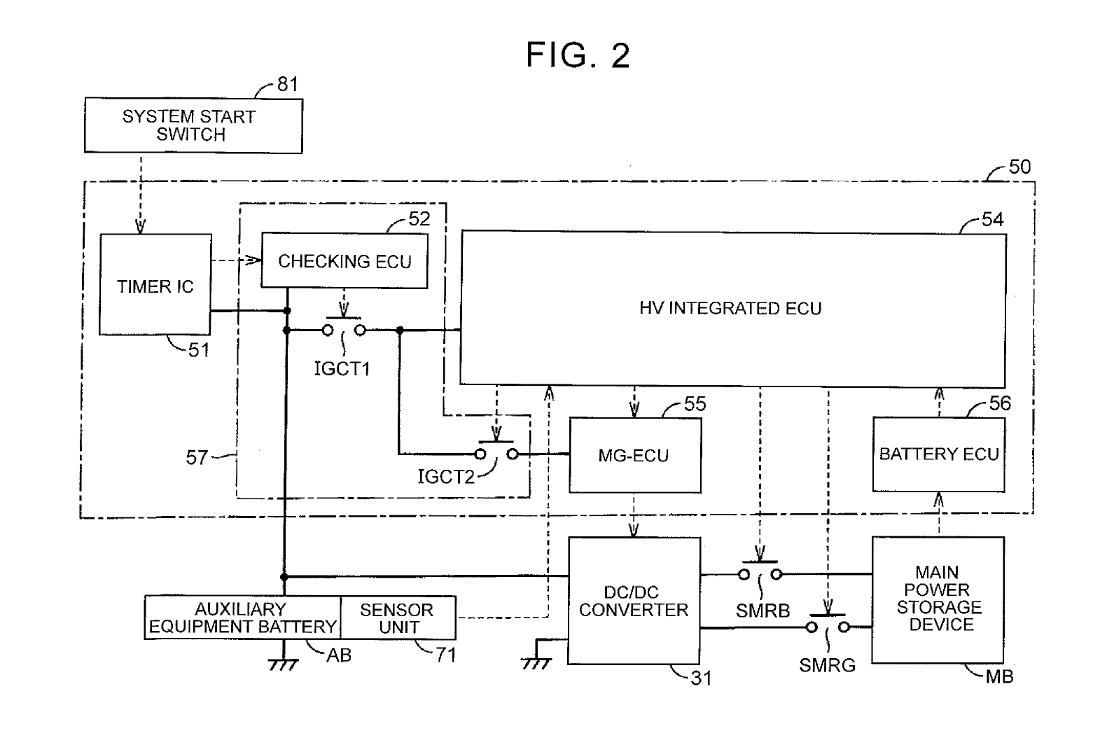

FIG. 2 is a diagram illustrating in detail the configuration of the control device 50 illustrated in FIG. 1. With reference to FIG. 2, the control device 50 has a timer integrated circuit (IC) 51, a checking electronic control unit (ECU) 52, a hybrid vehicle (HV) integrated ECU 54, an MG-ECU 55, a battery ECU 56, and switches IGCT1, IGCT2.

The control device 50 receives operating power from the auxiliary equipment battery AB. This operating power is constantly supplied to the timer IC 51 and the checking ECU 52, and is supplied to the HV integrated ECU 54 via the switch IGCT1, and to the MG-ECU 55 via the switch IGCT2 as well. The switches IGCT1, IGCT2 that are used may be mechanical switches such as relays, or semiconductor elements such as transistors.

The checking ECU 52 and the switches IGCT1, IGCT2 operate as a power supply control unit 57 that controls supply of power to the HV integrated ECU 54 and the MG-ECU 55. The checking ECU 52 checks whether a signal from a remote key (not shown) conforms to the vehicle 100 or not. If the checking result indicates that the remote key conforms to the vehicle, the checking ECU 52 brings the switch IGCT1 to a conducting state. As a result, operating power is supplied from the auxiliary equipment battery AB to the HV integrated ECU 54, and the HV integrated ECU 54 is started.

When started, the HV integrated ECU 54 brings the switch IGCT2 to a conducting state. As a result, operating power is supplied from the auxiliary equipment battery AB to the MG-ECU 55, and the MG-ECU 55 is started. The HV integrated ECU 54 receives, from the battery ECU 56, a signal denoting the state of the main power storage device MB (for instance, detection values of voltage and current of the main power storage device MB), and receives, from the sensor unit 71, a signal denoting the state of the auxiliary equipment battery AB (for instance, detection values of voltage and current of the auxiliary equipment battery AB). The HV integrated ECU 54 controls the system main relays SMRB, SMRG and the MG-ECU 55 on the basis of these various received signals.

The battery ECU 56 monitors the state of the main power storage device MB. The battery ECU 56 calculates the SOC of the main power storage device MB on the basis of the detection values of voltage, current and so forth of the main power storage device MB, and outputs the calculation result to the HV integrated ECU 54. The MG-ECU 55 controls the DC/DC converter 31 and the PCU 20 (FIG. 1) under the control of the HV integrated ECU 54.

As described above, the control device 50 receives operating power from the auxiliary equipment battery AB. Therefore, the control device 50 becomes operationally disabled, and as a result the vehicle 100 becomes also operationally disabled, when the power storage amount in the auxiliary equipment battery AB decreases. When the vehicle 100 is left in a state of system shutdown, the power storage amount in the auxiliary equipment battery AB decreases as time goes on. Accordingly, the above-described pumping charging is executed if the vehicle 100 has not been started over a long period of time, in order to recover the charge amount in the auxiliary equipment battery AB the power storage amount whereof had dropped.

The timer IC 51 is provided for the purpose of generating execution timing of pumping charging. The timer IC 51 outputs a start-up command of the checking ECU 52 when a predefined time, set in a built-in memory, has elapsed after system shutdown in the vehicle 100 as a result of a turn-off operation of the system start switch 81.

Upon reception of a start-up command from the timer IC 51, the checking ECU 52 brings the switch IGCT1 to a conducting state, even in the absence of a signal from the remote key. As a result, operating power is supplied from the auxiliary equipment battery AB to the HV integrated ECU 54, and the HV integrated ECU 54 is started. The HV integrated ECU 54 brings the switch IGCT2 and the system main relays SMRB, SMRG to a conducting state, and outputs, to the MG-ECU 55, a driving command that instructs driving of the DC/DC converter 31.

The HV integrated ECU 54 further determines an abnormality in the auxiliary equipment battery AB, on the basis of the information relating to dark current in the auxiliary equipment battery AB during parking. Herein, the HV integrated ECU 54 calculates the SOC decrease amount in the auxiliary equipment battery AB during parking, and if the calculated SOC decrease amount is larger than the predefined reference value, determines that the auxiliary equipment battery AB is in an abnormal condition. When the auxiliary equipment battery AB is determined to be in an abnormal condition, the HV integrated ECU 54 sets pumping charging control to non-execution, without bringing the switch IGCT2 and the system main relays SMRB, SMRG to a conducting state.

The configuration of the control device 50 illustrated in FIG. 2 is an example, and may accommodate various modifications. In FIG. 2, the control device 50 has a plurality of ECUs, but several ECUs may be integrated together, to configure thereby a control device 50 with fewer ECUs. Conversely, the control device 50 may be configured out of a greater number of ECUs.

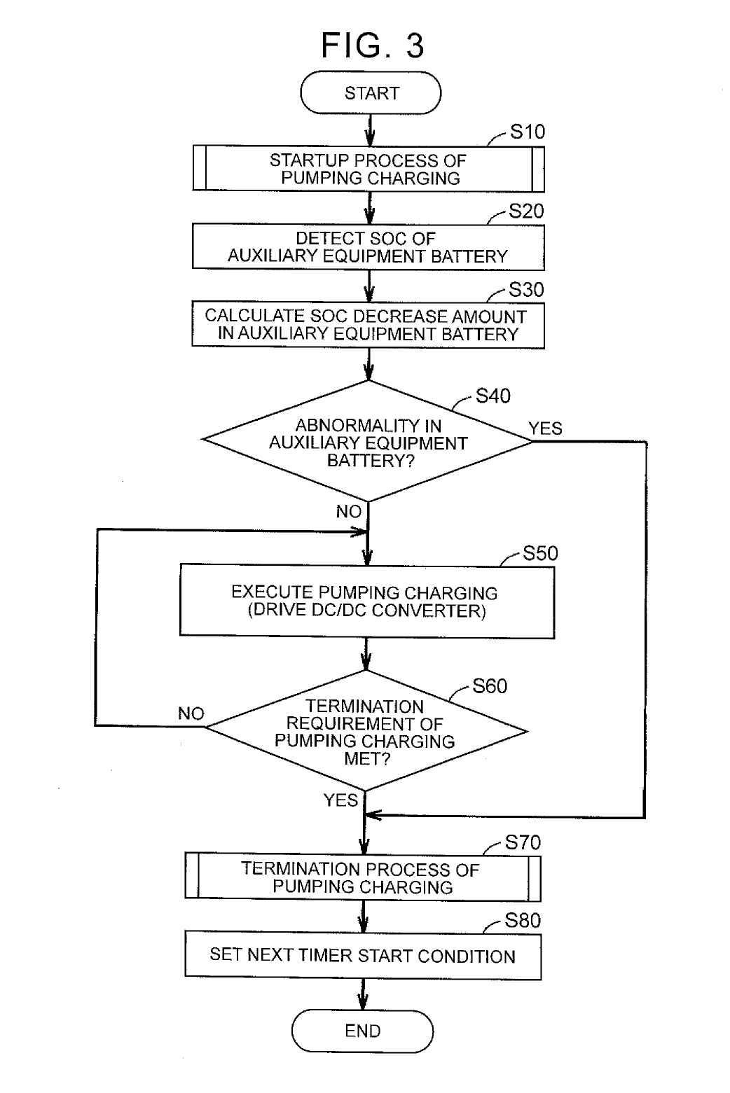

FIG. 3 is a flowchart for explaining the process steps in pumping charging control that is executed by the control device 50. With reference to FIG. 3 and FIG. 2, a subroutine for execution of a startup process of pumping charging is called when the user turns off the system start switch 81 (step S10).

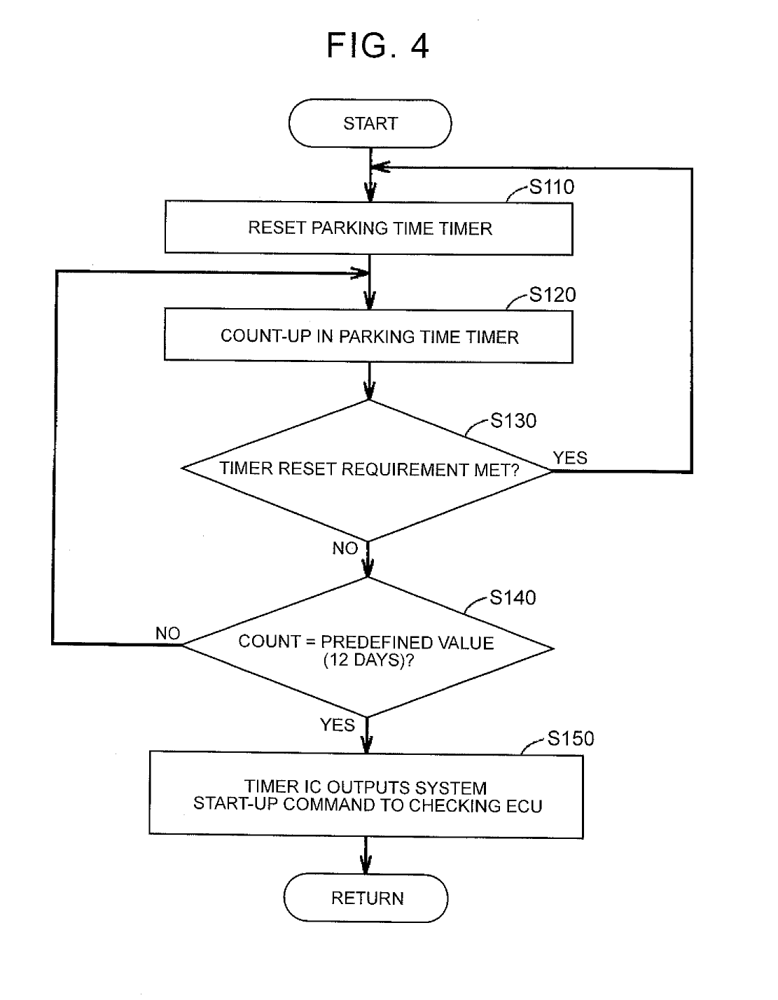

FIG. 4 is a flowchart for explaining the steps of the startup process of pumping charging, as executed in step S10 illustrated in FIG. 3. With reference to FIG. 4 and FIG. 2, firstly a parking time timer for measuring the parking time of the vehicle 100 is reset in the timer IC 51 (step S110). Upon reset of the parking time timer, the timer IC 51 initiates count-up of the parking time timer (step S120).

Next, the timer IC 51 determines whether a timer reset requirement is met or not (step S130). Specifically, the timer reset requirement is met when the system start switch 81 is turned on. When it is determined that the tinier reset requirement is met (YES in step S130), the process returns to step S110.

If in step S130 it is determined that the timer reset requirement is not met (NO in step S130), the timer IC 51 determines whether or not a value in the parking time timer arrived at through count-up (hereafter “count value”) matches (or exceeds) a predefined value (for instance, a value corresponding to 12 days) that is set in the memory. That is, it is determined whether the vehicle 100 has been left in a parked state for a predefined period (for instance, 12 days).

When it is determined that the count value does not match the predefined value in the memory (does not exceed the predefined value) (NO in step S140), the process returns to step S120. When it is determined that the count value matches the predefined value in the memory (or exceeds the predefined value) (YES in step S140), the timer IC 51 outputs the system start-up command to the checking ECU 52 (step S150). Upon reception of the system start-up command, the checking ECU 52 makes the switch IGCT1 conductive. The HV integrated ECU 54 is started as a result.

With reference back to FIG. 3, the HV integrated ECU 54 detects the SOC of the auxiliary equipment battery AB on the basis of a signal from the sensor unit 71 (step S20). The SOC of the auxiliary equipment battery AB may be calculated in the sensor unit 71, or may be calculated in the HV integrated ECU 54. Next, the HV integrated ECU 54 calculates the SOC decrease amount in the auxiliary equipment battery AB (step S30). Specifically, the HV integrated ECU 54 calculates, on the basis of the SOC detected in step S20, a SOC amount of the auxiliary equipment battery AB that has dropped over the period elapsed until the count value in the parking time timer reaches a predefined value (i.e. the period over which the vehicle 100 has been left in a parked state). The larger the dark current in the auxiliary equipment battery AB during parking, the larger becomes the SOC decrease amount in the auxiliary equipment battery AB. The HV integrated ECU 54 determines, on the basis of the SOC decrease amount in the auxiliary equipment battery AB as calculated in step S30, whether or not the auxiliary equipment battery AB is in an abnormal condition (step S40).

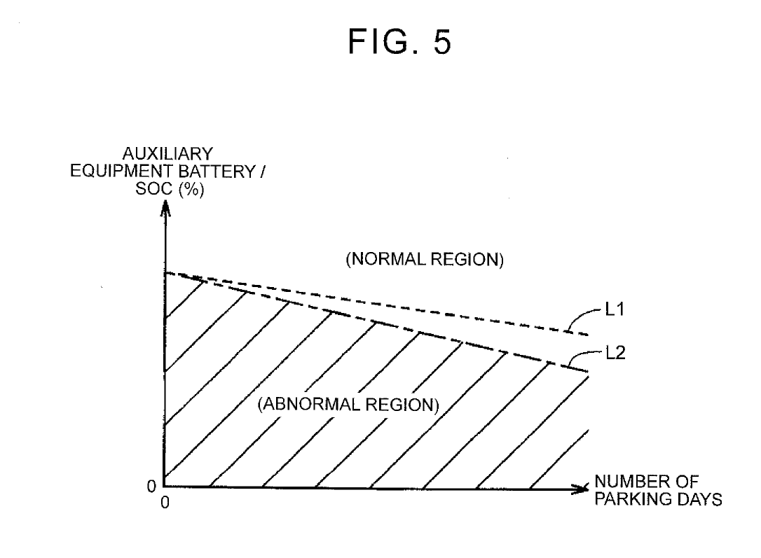

FIG. 5 is a diagram for explaining a method for determining abnormality in the auxiliary equipment battery AB. With reference to FIG. 5, the abscissa axis represents the number of parking days of the vehicle 100, and the ordinate axis represents the SOC of the auxiliary equipment battery AB. The SOC of the auxiliary equipment battery AB drops as the parking days pile up, since dark current flows also during parking. The dark current during parking can be predicted, and hence it is possible to estimate beforehand the SOC decrease amount corresponding to the number of parking days. A dotted line L1 denotes the drop in SOC at a time of a normal amount of dark current. A reference line L2 is defined on the basis of the dotted line L1, taking now into account, for instance, characteristic variability in the auxiliary equipment battery AB and the sensor unit 71, as well as a deterioration characteristic of the auxiliary equipment battery AB. The auxiliary equipment battery AB is determined to be in an abnormal condition if the SOC decrease amount is large enough so that the SOC during parking drops below the reference line L2.

With reference back to FIG. 3, the HV integrated ECU 54 brings the switch IGCT2 and the system main relays SMRB, SMRG to a conducting state when in step S40 it is determined that the auxiliary equipment battery AB is in a normal condition (NO in step S40). The HV integrated ECU 54 outputs, to the MG-ECU 55, a driving command of the DC/DC converter 31, and the DC/DC converter 31 is caused to operate, to execute pumping charging thereby (step S50).

Next, the HV integrated ECU 54 determines whether a termination requirement of pumping charging is met or not (step S60). Herein, instances corresponding to a termination, requirement include, among others, instances where the time over which any of the doors of the vehicle 100 is open, or the execution time of pumping charging goes on for a time that is equal to or longer than a predefined time (for instance, 10 minutes), or instances where the SOC of the main power storage device MB drops below a predefined value. Herein, the predefined time (for instance, 10 minutes) is established in relation to the predefined value (for instance, value corresponding to 12 days) in step S140 (FIG. 4). In a case where a time that suffices in order to achieve charge equivalent to 12 days of discharge amounts for instance to 10 minutes, then this time (10 minutes) is established for the predefined value (12 days).

A door being open was set above as a termination requirement, but other instances may be set as termination requirements, for example, an instance where the engine hood is open, an instance where a door lock is released, an instance where a brake pedal is depressed, an instance where an auto-alarm system is brought to a warning state, or an instance where a remote key has been detected. In all these instances, the user is expected to be touching the vehicle, or to be standing in the vicinity of the vehicle, or to be drawing closer to the vehicle in response to a warning. Accordingly, it is deemed that there is a high likelihood that the vehicle system will be started by the user. Providing a termination requirement allows thus pumping charging to be executed safely.

When in step S60 it is determined that the termination requirement of pumping charging is not met (NO in step S60), the process returns to step S50. On the other hand, when it is determined that the termination requirement of the pumping charging is met (YES in step S60), there is executed the termination process of pumping charging (step S70). Specifically, a shutdown command is outputted to the DC/DC converter 31, and the system main relays SMRB, SMRG are brought to a cut-off state.

Upon execution of the termination process of pumping charging there is set a next timer start condition (step S80). Specifically, the start timing of the next pumping charging process is set in such a manner that draining of the auxiliary equipment battery AB can be avoided as much as possible, if pumping charging is discontinued while in progress or is not initiated.

On the other hand, when it is determined in step S40 that the auxiliary equipment battery AB is in an abnormal condition (YES in step S40), the HV integrated ECU 54 moves the process on to step S70. Specifically, when it is determined that the auxiliary equipment battery AB is in an abnormal condition, the HV integrated ECU 54 sets pumping charging to non-execution, without bringing the switch IGCT2 and the system main relays SMRB, SMRG to a conducting state, and, without driving the DC/DC converter 31.

In the present embodiment, as described above, pumping charging control by the DC/DC converter 31 is not executed when it is determined that the auxiliary equipment battery AB is in an abnormal condition, on the basis of information relating to dark current in the auxiliary equipment battery AB during parking. Therefore, power is not fed from the main power storage device MB to the auxiliary equipment battery AB when an abnormality occurs in the auxiliary equipment battery AB. In consequence, the present embodiment allows suppressing abnormal heat generation in the auxiliary equipment battery AB.

In the above embodiment, pumping charging is discontinued when it is determined that the auxiliary equipment battery AB is in an abnormal condition, but a configuration may be adopted wherein pumping charging is discontinued if it is determined that dark current in the auxiliary equipment battery AB is larger than a predefined value (a value that may be deemed as abnormal), without performing determination of abnormality of the auxiliary equipment battery AB.

For instance, a configuration may be adopted wherein pumping charging is discontinued upon determination that dark current in the auxiliary equipment battery AB is larger than a predefined value, if the SOC decrease amount or voltage decrease amount in the auxiliary equipment battery AB during parking is larger than a respective predefined reference value. The predefined reference value can be established on the basis of the power consumption in the auxiliary equipment load 30 during parking, as described above. Alternatively, dark current in the auxiliary equipment battery AB during parking may be detected directly by a current sensor that is provided in the sensor unit 71, such that pumping charging may be set to be discontinued if the detection value of dark current is larger than a predefined value.

In the above embodiment, the vehicle 100 is configured in the form of a hybrid vehicle equipped with the motor generators MG1, MG2 and the engine 2 as drive sources. However, the scope of the invention is not limited to such a hybrid vehicle.

The invention encompasses also, among others, vehicles such as electric automobiles equipped with no engine 2, and fuel cell vehicles that are further equipped with a fuel cell as an energy source. The PCU 20 is configured to be provided with the converter 21. However, the invention can be used in vehicles equipped with a PCU that has no converter 21.

The main power storage device MB corresponds to an embodiment example of the “first power storage device” of the invention, and the auxiliary equipment battery AB corresponds to an embodiment example of the “second power storage device” of the invention. The DC/DC converter 31 corresponds to an embodiment example of the “voltage conversion device” of the invention, and the PCU 20 and the motor generator MG2 constitute embodiment examples of the “driving device” of the invention.

The embodiments disclosed herein are, in all features thereof, exemplary in nature, and are not meant to be limiting in any way. The scope of the invention, which is defined by the appended claims, and not by the explanation of the above embodiments, is meant to encompass equivalents as well as all modifications of the claims.

1. A power supply system of a vehicle, comprising:
a first power storage device that stores power for travel;
a second power storage device that stores power for auxiliary equipment;
a voltage conversion device that is provided between the first power storage device and the second power storage device, and that charges the second power storage device through voltage conversion of power that is outputted by the first power storage device; and
a control device that executes charging control of charging the second power storage device by way of the voltage conversion device, while the vehicle is parked, and that determines an abnormality in the second power storage device on the basis of information relating to dark current in the second power storage device during parking, and, upon determination of abnormality in the second power storage device, sets the charging control to non-execution.

2. The power supply system of a vehicle according to claim 1, wherein
the information relating to the dark current includes a state quantity that denotes a state of charge of the second power storage device, and
the control device determines that the second power storage device is in an abnormal condition when a decrease amount of the state quantity during parking is larger than a predefined reference value.

3. The power supply system of a vehicle according to claim 2, wherein
the predefined reference value is established on the basis of power consumption, during parking, of an auxiliary equipment load that is installed in the vehicle.

4. A power supply system of a vehicle, comprising:
a first power storage device that stores power for travel;
a second power storage device that stores power for auxiliary equipment;
a voltage conversion device that is provided between the first power storage device and the second power storage device, and that charges the second power storage device through voltage conversion of power that is outputted by the first power storage device; and
a control device that executes charging control of charging the second power storage device by way of the voltage conversion device, while the vehicle is parked, and that sets the charging control to non-execution when it is determined that dark current in the second power storage device during parking is larger than a predefined value.

5. The power supply system of a vehicle according to claim 4, wherein
the control device determines that the dark current is larger than the predefined value when a decrease amount, during parking, of a state quantity that denotes a state of charge of the second power storage device is larger than a predefined reference value.

6. The power supply system of a vehicle according to claim 5, wherein
the predefined reference value is established on the basis of power consumption, during parking, of an auxiliary equipment load that is installed in the vehicle.

7. A vehicle, comprising:
the power supply system of a vehicle according to claim 4; and
a driving device that generates a driving force by receiving power from the power supply system.

8. A vehicle, comprising:
the power supply system of a vehicle according to claim 1; and
a driving device that generates a driving force by receiving power from the power supply system.
